(19) United States
(12) Patent Application Publication
(10) Pub. No.: US 2023/0323712 A1
(43) Pub. Date: Oct. 12, 2023

(54) Storage Door Locked Open Insert

(71) Applicant: U-Haul International, Inc, Phoenix, AZ (US)

(72) Inventors: Corey Mardones, Pittsfield, NH (US); Tara Mardones, Pittsfield, NH (US); Eric Edward Taylor, El Paso, TX (US)

(21) Appl. No.: 18/191,764

(22) Filed: Mar. 28, 2023

Related U.S. Application Data
(60) Provisional application No. 63/362,110, filed on Mar. 29, 2022.

(51) Int. Cl. E05C 1/04; E05C 19/18; E05C 1/00

(52) U.S. Cl. CPC E05C 19/188; E05C 1/004; E05C 1/04

(57) ABSTRACT

An improvement for use with a door latch assembly for a roll-up door includes a shim dimensioned and shaped to be positioned over a latch cover of the latch door assembly and to be slidingly moved to a shim extended position wherein a shim tang extends beyond a latch slide tang of the latch assembly. The shim is configured so that, if the latch assembly is mounted to a rolling door and is locked into an unsecured position by a first lock, wherein the slide tang does not engage the door jamb, the shim can be moved to and locked in the shim extended position to secure the rolling door without removing the first lock.

### RELATED APPLICATIONS

This application claims priority of, and incorporates by reference, U.S. Provisional Pat. Application Serial No. 63/362,110, filed Mar. 29, 2022, entitled Storage Door Locked Open Insert.

### BACKGROUND

The present invention relates to door latch assemblies for roll-up doors. More specifically, it relates to an improvement for a door latch assembly of a rolling door that that has a latch slide locked in an unsecured position by a first lock, wherein the improvement includes a shim that can be inserted into the door latch assembly to secure and lock the door without removing the first lock.

Roll-up doors are commonly used in rental storage unit facilities, commonly known as “mini-storage” places. A storage unit usually consists of a storage room with access controlled by a roll-up door. The door is secured by a lock, such as a key or combination lock with a shank, hasp or shackle which is attached to the door latch mechanism. When locked, the door latch has a tongue, pin or other object that slides to project into a space in the door frame, thus preventing access to the storage room.

One previously-known door latch assembly for securing the door of a storage unit is shown in U.S. Pat. No. 6,719,334 B1 to Curtis and entitled “Door Latch Assembly for Roll-Up Door,” which is incorporated herein in its entirety by this reference as is fully set forth herein. As discussed in more detail below, one of the shortcomings of this door latch assembly is that users of storage units sometimes inadvertently lock the door latch in an open (i.e., unsecured) position mistakenly believing that it is locked in the closed (i.e., secured) position. When this occurs, there is a potential for theft of the possessions of a user who inadvertently locked the storage unit open. Moreover, a manager or operator of the storage unit who cannot remove the lock cannot move the latch to closed position to secure the storage unit door.

There is a need, therefore, for an apparatus and method that addresses the foregoing problem. It is an object of the present invention to provide such an apparatus.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, there is provided an improvement for use with a door latch assembly for a roll-up door. The improvement includes a shim dimensioned and shaped to be positioned over at least a portion of a latch cover of the latch door assembly and to be slidingly moved to a shim extended position wherein a shim tang extends beyond a latch slide tang of the latch assembly. The shim is configured so that, if the latch assembly is mounted to a rolling door and is locked into an unsecured position by a first lock, the shim can be moved to and locked in the shim extended position to secure the rolling door without removing the first lock.

### BRIEF DESCRIPTION OF THE DRAWINGS

The accompanying drawings, which are incorporated in and constitute a part of the specification, illustrate the presently preferred embodiments of the invention and, together with the general description given above and the detailed description of the preferred methods and embodiments given below, serve to explain the principles of the invention.

FIG. 1 is a perspective view of a prior door latch assembly showing the latch slide in the fully retracted and unlatched position.

FIG. 2 is a perspective view of the door latch assembly of FIG. 1 showing the latch slide in the latched position.

FIG. 3 is a front elevation view of the latch cover of the door latch assembly of FIG. 1.

FIG. 4 is a top plan view of the latch cover of FIG. 3.

FIG. 5 is a side elevation view of the the latch cover of FIG. 3.

FIG. 6 is a perspective view of the latch slide of the door latch assembly of FIG. 1.

FIG. 7 is a front elevation view of the latch slide of FIG. 6

FIG. 8 is a bottom plan view of the latch slide of FIG. 6.

FIG. 9 is a front perspective view of the latch assembly of FIG. 1 shown mounted to a rollup door of a storage unit.

FIG. 10 is a top perspective view of the latch assembly of FIG. 1 shown mounted to a rollup door of a storage unit with the latch slide moved to a position wherein the latch assembly can be inadvertently locked in an open (unsecured) position.

FIG. 11 is a perspective view of a door-open insert shim according to one embodiment of the present invention.

FIG. 12 is a front elevation view of the insert shim of FIG. 11.

FIG. 13 is a top plan view of the insert shim of FIG. 11.

FIG. 14 illustrates the steps for using the insert shim of FIG. 11 according to the present invention to secure a rollup door with a latch assembly that has been locked in an open (unsecured) position.

FIG. 15 is a perspective view of a door-open insert shim according to another embodiment of the present invention.

FIG. 16 is a front elevation view of the insert shim of FIG. 15.

FIG. 17 is a top plan view of the insert shim of FIG. 15.

### DETAILED DESCRIPTION

Reference will now be made in more detail to presently preferred embodiments of the invention, as illustrated in the accompanying drawings. While the invention is described more fully with reference to these examples and drawings, the invention in its broader aspects is not limited to the specific details, representative devices, and illustrative examples shown and described. Rather, the description, which follows is to be understood as a broad, teaching disclosure directed to persons of ordinary skill in the appropriate arts, and not as limiting upon the invention.

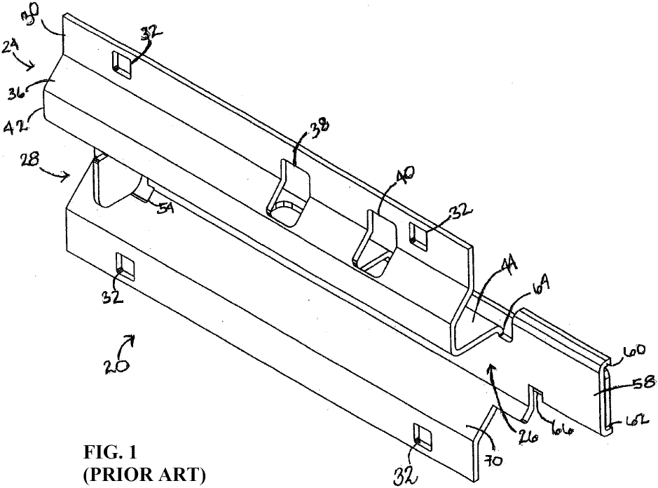

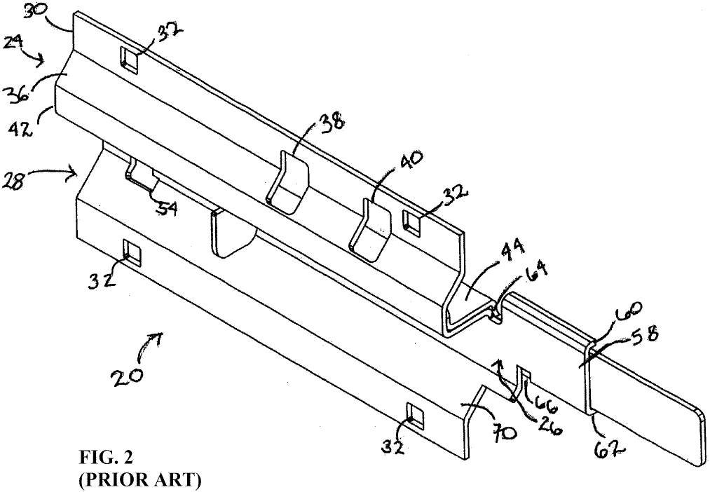

It will be appreciated that terms such as “forward,” “rearward,” “upward,” “downward,” “upper,” “inner,” “outer,” “vertical,” “horizontal,” “bottom,” “below,” “top,” “side,” “inwardly,” “outwardly,” “downwardly” and “lower” and other positional descriptive terms used in this specification are used merely for ease of description and refer to the orientation of the referenced components as shown in the figures. It should be understood that any orientation of the components described herein is within the scope of the present invention. The term “generally” as used in this specification is defined as “being in general but not necessarily exactly or wholly that which is specified.” For example, “generally perpendicular” is used herein to indicate components that are in general, but not necessarily exactly or wholly, perpendicular. As used in this description and in the claims, unless the context requires otherwise, the terms “proximal” and “proximally” shall refer to a location nearer or a direction toward the end of the latch assembly with the aperture 54 (as can be seen in FIGS. 1 and 2) the terms “distal” and “distally” shall refer to a location nearer or in a direction toward the other end of the latch assembly.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

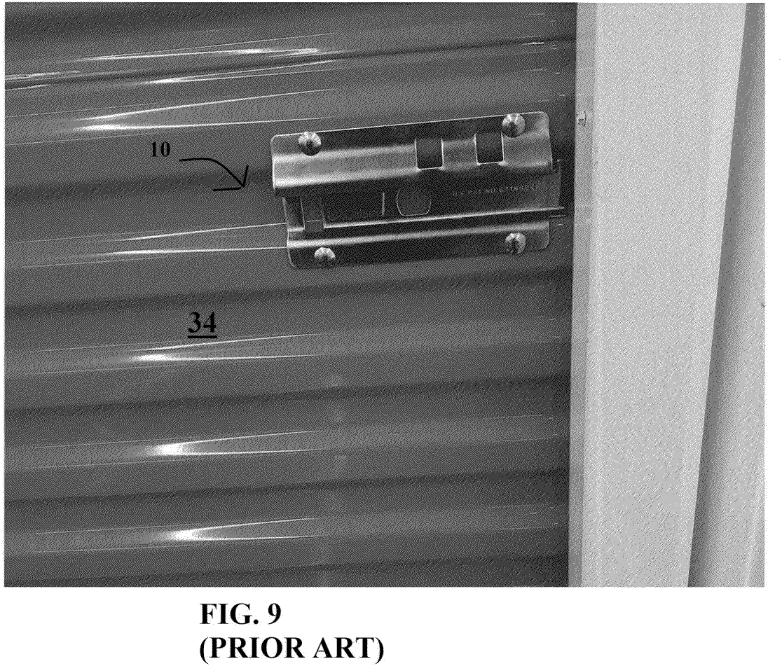

For purposes of explanation, and to further assist in the understanding of this invention, a brief description of the operation of a previously-known latch assembly for roll-up doors follows. FIGS. 1-9 illustrate such a door latch assembly 10, which includes a latch cover 20 and a latch slide 22. FIG. 1 shows the latch assembly 10 with the latch slide 22 in the retracted position and FIG. 2 shows the latch slide 22 in the extended position within the latch cover 20.

The latch cover 20 has an upper section 24, a middle section 26 and a lower section 28. The upper section 24 has an upper vertical portion 30 with spaced apart bolt apertures 32. Depending from the vertical portion 30 is an angled portion 36. Apertures 38, 40 are defined in the vertical portion 30 and angled portion 36. A lower vertical portion 42 depends downward from the angled portion 36. A horizontal portion 44 extends horizontally from the lower vertical portion 42. As can be seen in FIG. 5, the upper section 24 extends beyond the lower section 28 when installed on a door curtain 34. Also, as can be seen in FIGS. 1-2 and 4, the horizontal portion 44 has an elongated proximal slot 50, intermediate slot 46 and a distal slot 48 defined therein. The slots 46 and 48 are aligned with the apertures 38 and 40 in the vertical portion 30. The aperture 38 and the intermediate slot 46 are aligned and sized to accommodate a conventional lock shank (not shown). Similarly, the aperture 40 and the distal slot 48 are aligned and sized to accommodate the shank of a lock. The horizontal portion 44 also has an elongated proximal slot 50 defined therein which can accommodate part of the latch 22, as discussed further below.

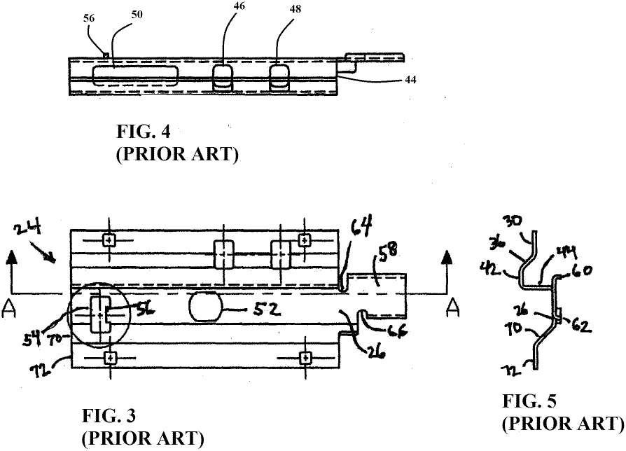

Still referring to FIGS. 1-9, the middle section 26, with which the horizontal portion 44 is associated, is generally parallel to the vertical portion 42. As shown in FIG. 3, the middle section 26 has an aperture 52 which can accommodate a conventional cylinder lock (not shown). An aperture 54 having a side tab 56 is formed towards one end (shown as the left end in FIGS. 1-3) of the middle section 26. The side tab 56 is bent towards the back of the middle section 26. The side tab 56 acts as a spacer to permit the latch slide 22 to move more freely when installed on the door curtain 34. A slide guide 58 extends from the other end of the middle portion 26. The slide guide 58 has spacer legs 60 and 62 extending from the upper and lower edges of the guide 58 to provide a guide for the latch slide 22. The spacer legs 60 and 62 act with the tab 56 to space the middle section 26 away from the door curtain 34 when installed to permit movement of the latch slide 22 (see FIGS. 3-5).

The lower section 28 has an angled portion 70 depending downward from the middle portion 26. At the left side (as shown in FIG. 1) is part of the aperture 54 which extends from the middle portion 26. Depending downward from the angled portion 70 is a lower vertical portion 72, which is generally parallel with the upper vertical portion 30. Apertures 32 are defined in the lower vertical portion 72 for accommodating a bolt or bolts.

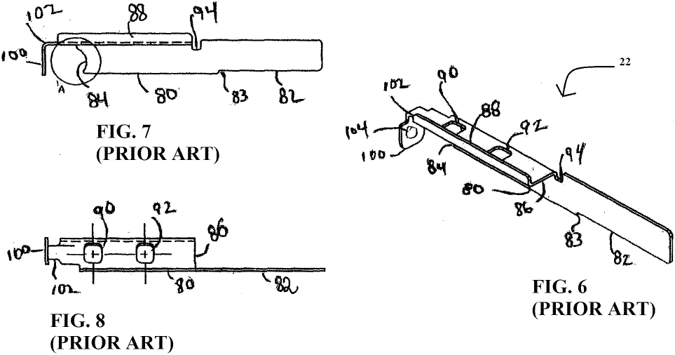

As can be seen in FIGS. 6-8, the latch slide 22 has a vertical portion 80, extending from one side of which (i.e., the latch slide distal end) is a tang 82. The tang 82 has a notch 83 at one side (shown as the right side in FIG. 7) which acts as a stop. At the other side of the latch slide 22 (i.e., the latch slide proximal end) is a notch 84, which is curved to generally match a portion of the curve of the aperture 52 so that when the latch slide 22 is in place and in the extended position, the cylinder lock can pass through the latch slide notch 84 and the aperture 52.

Extending horizontally from the top edge of the vertical portion 80 is a horizontal portion 86, which terminates at one side in a vertically and upwardly extending section 88. In the horizontal portion 86 is an aperture 90 and an aperture or slot 92, which are sized and positioned to align with the apertures 38 and 40 and the slots 46 and 48, respectively, when the latch slide 22 is in the extended position in the latch cover 20 (shown in FIG. 2). A pull tab 100 extends from the left side of the horizontal portion 86 by way of a right-angle portion 102. The pull tab 100 has a hole 104 defined therein which can accommodate a cable, wire or other implement which can be attached to a handle, ring, strap, T-bar or the like to facilitate grasping, such as by individuals with difficulties in manual dexterity.

To assemble the latch slide 22 and latch cover 20, the pull tab 100 and the right-angle portion 102 of the latch slide 22 are inserted at an angle into the elongated proximal slot 50 in the latch cover 20. The tang 82 will slide in the spacer legs 60 and 62 with the vertical portion 80 being parallel to the vertical portion 26. When assembled, there is a small space between the right-angle portion 102 of the pull tab 100 and the middle section 26 of the latch cover 20. As can be seen in FIG. 1, when the latch slide 22 is in the retracted position, the tang 82 resides substantially within the spacer legs 60 and 62 and the slide guide 58. When the pull tab 100 is slid to the right to extend the tang 82, the tang 82 can engage a slot in the jamb of a conventional door. When the latch slide 22 is so extended, the aperture 90 is aligned with the aperture 38 and the intermediate slot 46 in the latch cover 20 so that a lock shank can be inserted therein. Similarly, the aperture 92 is aligned with the aperture 40 and the distal slot 48 in the latch cover 20 so that another lock shank can be inserted therein. While most users of the latch assembly 10 of the present invention will only use a single lock, the second aperture combination is provided so that a second lock can be accommodated. This may be useful in a storage facility where the occupant of the storage unit has not paid rent and the property manager attaches a lock to the assembly 10 to prevent the renter from accessing the storage unit until the second lock is removed.

Having described the operational characteristics of a prior latch assembly 10, the features of an improved latch assembly according to the present invention will now be described. As previously mentioned, one shortcoming of the prior latch assembly 10 described above is that it can be inadvertently locked in a partially retracted position (aka a partially extended position) by a user (e.g., a customer of the storage unit) who believes they have locked the latch assembly in the fully extended position shown in FIG. 2. This can result in the user inadvertently locking the storage unit door in an unsecured position and then leaving the unit believing that the latch assembly is locked in the fully extended position and the unit is secured when, in fact, it is not. Because the latch assembly is locked in a retracted position, the latch slide 22 cannot be moved to the fully extended position to secure the storage unit door without removing the lock. Consequently, a manager or operator of the storage unit who cannot remove the lock also cannot move the latch slide to the fully extended position to secure the storage unit door.

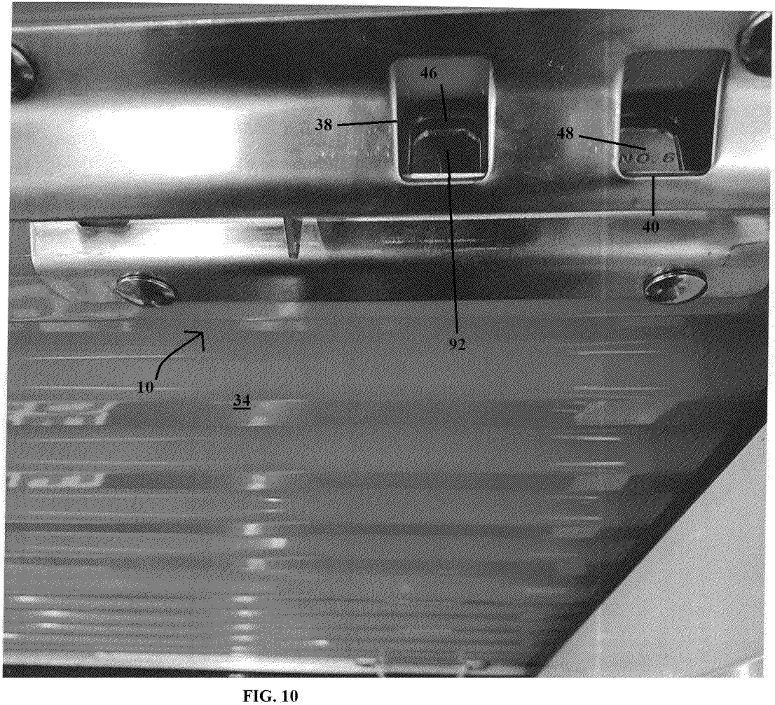

FIG. 10 illustrates the latch assembly 10 mounted to a rollup door of a storage unit with the latch slide 22 moved to a position wherein the latch assembly can be inadvertently locked in an open (unsecured) position. In this situation, the latch slide 22 has been moved to a partially extended position but not to the fully extended position shown in FIG. 2. In this partially extended position, the aperture 90 is not aligned with the aperture 38 and intermediate slot 46 in the latch cover 20 and the aperture 92 is not aligned with the aperture 40 and distal slot 48 in the latch cover 20. Instead, the aperture 92 in the latch slide 22 is aligned with the aperture 38 in the latch cover 20. In this position, the tang 82 does not engage the slot in the door jamb and the rolling door 34 therefore is not secured in a closed position. The latch assembly 10 can be locked in this partially extended position by inserting a shank of a first lock 210 through the aligned apertures 92, 38 and securing the lock 210. If this occurs, the latch assembly 10 will be locked in the partially extended position with the door not secured. This can be done inadvertently by a user who does not realize the latch assembly has been locked with the door in an unsecure (i.e., unlocked) position.

Upon review of this disclosure, it will also be understood that the latch assembly 10 can be locked in an open (unsecured) position wherein the shank of the first lock 210 is inserted through the aperture 40 and distal slot 48 of the latch cover 20.

In accordance with the present invention, an insert shim 200 can be used to secure a rolling door 34 that has a latch assembly 10 locked in an open position with a first lock 210 as described above, without having to remove the first lock 210. The insert shim 200 is positioned over the latch cover middle section 26 and slidingly moved into engagement with the storage units’ door jamb slot and room alarm contact, then the insert shim 200 is locked to the latch cover 20 using a second lock 212 as described below. This allows a manager or operator of the storage unit to lock the unit door in a secure position without having to remove the first lock 210.

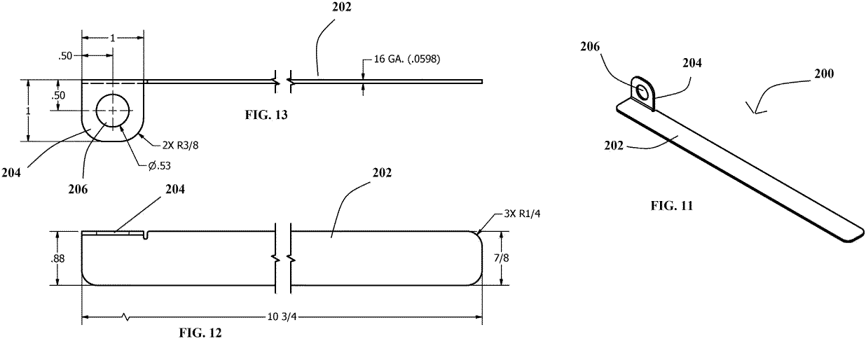

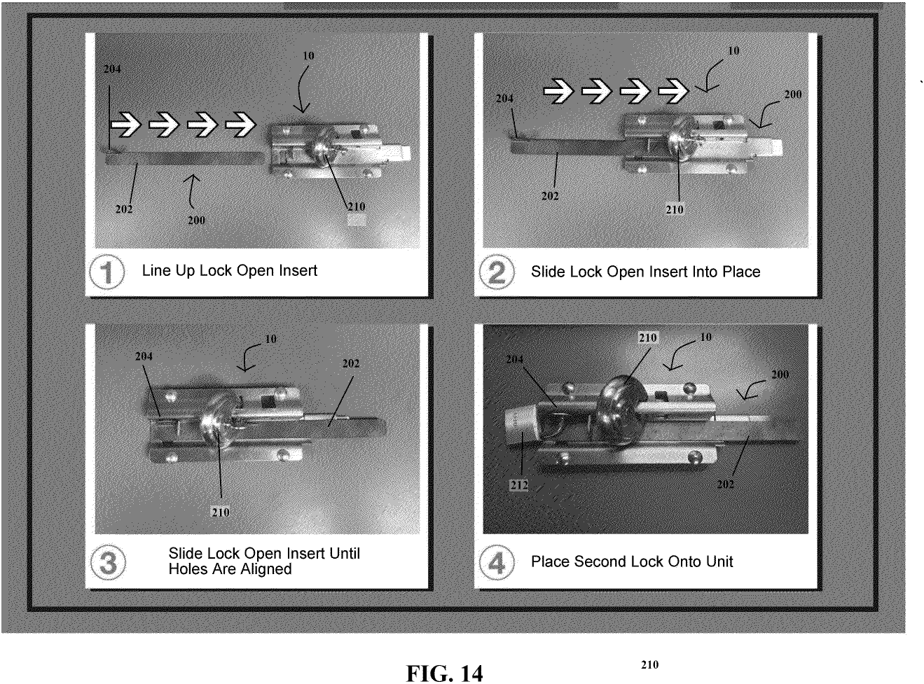

Referring to FIGS. 11-14, one exemplary embodiment of the insert shim 200 has a shim tang 202 and a shim tab 204. The shim tab 204 includes a hole 206 for receiving the shank of a second lock 212. The shim 200 is dimensioned and shaped so that the shim tang 202 can be inserted through the small space between the right-angle portion 102 of the pull tab 100 and the middle section 26 of the latch cover 20. As shown in FIG. 14, the shim 200 is long enough so that after such insertion, the shim tang 202 can be slidingly advanced over the middle section 26 of the latch cover 20 in a distal direction (shown as rightward in FIGS. 3 and 4) to engage the slot in the jamb of the rollup door 34 and align the shim tab hole 206 with the elongated proximal slot 50 in the latch cover 20. As shown in FIG. 14, when the shim 200 is inserted in this fashion, the shim tab 204 is positioned to the left (i.e, proximally) of the latch slide pull tab 100 and the door 34 can be secured in the closed position by inserting the shank of the second lock 212 through the aligned shim tab hole 206 and the elongated proximal slot 50 in the slide cover 20 and locking the second lock 212. In the embodiment depicted in FIGS. 11-14, for example, the length of the shim 200 is 10 ¾ inches (see FIG. 12) and the shim 200 is fabricated from steel.

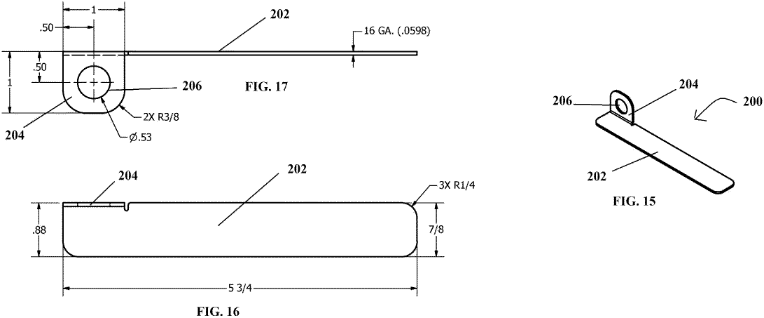

In other embodiments, the insert shim 200 can be shorter than the embodiment of FIGS. 11-14. In one such embodiment, as shown in FIGS. 15-17, the shim 200 can be placed in front of the middle section 26 of the latch cover 20 with the shim tab 204 to the right (as oriented in FIG. 14) of the pull tab 100 of the latch slide 22. In this placement, the shim 200 has a length so that the shim tang 202 can be slid into the slot in the door jamb of the rollup door 34 with the shim tab hole 206 aligned with the aperture 40 and slot 48 in the latch cover 20. For example, the shim 200 can have a length of 5 ¾ inches and also can be made of steel. When this shorter embodiment of the shim 200 is inserted in this fashion, the door 34 can be secured in the closed position by inserting the shank of the second lock 212 through the aligned shim tab hole 206, aperture 40 and distal slot 48 and locking the second lock 212.

In still another embodiment of an insert shim that is shorter than that of FIGS. 11-14, the shim 200 can be used to secure the door when the shank of the first lock 210 is inserted through the aperture 40 and distal slot 48 of the latch cover 20. With this embodiment, the shim 200 is of a length such that the shim tab hole 206 can be aligned with the aperture 38 and intermediate slot 46 in the latch cover 20 when the shim 200 is engaged in the slot of the door jamb. The shim 200 is placed in front of the middle section 26 of the latch cover 20 with the shim tab 204 distally (i.e, to the right as oriented in FIG. 14) of the pull tab 100 of the latch slide 22. With the shank of the first lock 210 inserted through the aperture 40 and distal slot 48 of the latch cover 20, the shim tab hole 206 can be aligned with the aperture 38 and intermediate slot 46 in the latch cover 20 when the shim 200 is engaged in the slot of the door jamb. In one example of this embodiment, the shim 200 can have a length of 7 ⅜ inches and also can be made of steel.

From the foregoing, it can be seen that the apparatus of the present invention possesses several advantages. It provides an improvement for a door latch assembly of a rolling door that can be locked in an unsecured position with a first lock, wherein the improvement allows a user to secure and lock the door without removing the first lock.

Upon reading this disclosure, additional advantages and modifications will readily occur to those skilled in the art. For example, although the embodiments described in this specification illustrate a shim for a door latch assembly to be mounted to the right side of a rolling door, it will be understood that such a shim could also be configured for use with a door latch assembly to be mounted to the left side of a rolling door. Therefore, the invention in its broader aspects is not limited to the specific details, representative devices, and illustrative examples shown and described. Accordingly, departures may be made from such details without departing from the spirit or scope of the general inventive concept.

What is claimed is:

1. An improved door latch assembly for a roll-up door, the door latch assembly comprising:
a latch cover, an elongated latch slide, and an elongated shim:
(i) wherein the latch cover includes an elongated upper section and a downwardly depending middle section;
wherein the latch cover upper section includes a generally horizontal portion that defines an elongated proximal slot disposed generally parallel to the latch cover upper section, an intermediate slot, and a distal slot, wherein each of the intermediate slot the distal slot is sized to accommodate a shank of a first lock; and
wherein the latch cover middle section includes a slide guide configured to receive the latch slide and, when the latch cover is unlocked, to permit a sliding, reciprocating movement of the latch slide between a latch slide retracted position and a latch slide extended position;
(ii) wherein the latch slide includes:
a generally vertical portion, a pull tab at a latch slide proximal end, and a latch slide tang at a latch slide distal end;
a latch slide horizontal portion extending generally perpendicularly from the latch slide vertical portion and defining a latch slide proximal aperture sized to accommodate the shank of the first lock and a latch slide distal aperture sized to accommodate the shank of the first lock; and
wherein the latch slide proximal aperture is positioned so that when the latch slide is in the latch slide extended position, the latch slide proximal aperture aligns with the intermediate slot of the latch cover upper section and the latch slide distal aperture aligns with the distal slot of the latch cover upper section; and
(iii) wherein the shim:
is dimensioned and shaped to be positioned over at least a portion of the latch cover middle section and slidingly moved to a shim extended position wherein the shim tang extends distally beyond the latch slide tang and
(iv) wherein the shim is configured so that, if the latch assembly is mounted to a rolling door and locked into a position with the shank of the first lock positioned through the latch slide distal aperture and the intermediate slot, the shim can be positioned over at least a portion of the latch cover middle section and slidingly moved to the shim extended position without removing the first lock.

2. The improved door latch assembly of claim 1, wherein the shim includes a shim tab at a shim proximal end and a shim tang at a shim distal end, and wherein the shim tab includes a hole sized to accommodate the shank of a second lock.

3. The improved door latch assembly of claim 1, wherein the shim is dimensioned and shaped so that the shim can be positioned over at least a portion of the latch cover middle section by inserting the shim tang through a space between the latch slide pull tab and the latch cover middle section.

4. The improved door latch assembly of claim 1, wherein the shim has a length so that when the shim is positioned in the shim extended position, the shim proximal end is positioned proximally of the latch slide tab.

5. The improved door latch assembly of claim 1, wherein the shim has a length so that when the shim is positioned in the shim extended position, the shim proximal end is positioned proximally of the latch slide proximal end.

6. The improved door latch assembly of claim 1, wherein the shim has a length so that when the shim is positioned in the shim extended position, the proximal end of the shim is positioned distally of the latch slide tab.

7. The improved door latch assembly of claim 1, wherein the shim has a length so that when the shim is positioned in the shim extended position, the proximal end of the shim is positioned distally of the latch slide proximal end.

8. The improved door latch assembly of claim 1, wherein the shim is further configured so that it can be locked to the door latch cover in the shim extended position without removing the first lock.

9. A shim for use with a door latch assembly for a roll-up door, the shim comprising:
a shim dimensioned and shaped to be positioned over at least a portion of a latch cover of the latch door assembly and to be slidingly moved to a shim extended position wherein a shim tang extends beyond a latch slide tang of the latch assembly; and
wherein the shim is configured so that, if the latch assembly is mounted to a rolling door and is locked into an unsecured position with a first lock, the shim can be moved to the shim extended position without removing the first lock.

10. The shim of claim 9 wherein the shim is further configured so that it can be locked to the door latch assembly in the shim extended position without removing the first lock.

11. The shim of claim 9 wherein the shim includes a shim tab at a shim proximal end and the shim tang at a shim distal end and wherein the shim tab defines a tab hole sized to accommodate a shank of a second lock.

12. The shim of claim 9, wherein the shim has a length so that when the shim is positioned in the shim extended position, a shim proximal end is positioned proximally of a latch slide tab.

13. The shim of claim 9, wherein the shim has a length so that when the shim is positioned in the shim extended position, a shim proximal end is positioned proximally of a latch slide proximal end.

14. The shim of claim 9, wherein the shim has a length so that when the shim is positioned in the shim extended position, a proximal end of the shim is positioned distally of a latch slide tab.

15. The shim of claim 9, wherein the shim has a length so that when the shim is positioned in the shim extended position, a proximal end of the shim is positioned distally of a latch slide proximal end.

16. A method for securing a rollup door having a door latch assembly that has been locked via a first lock in unsecured position wherein a latch slide of the locked door latch does not engage a slot in a jamb of the rollup door, the method comprising:
providing a shim;
inserting the shim into the locked door latch assembly; and
slidingly advancing the shim in a direction generally parallel to the latch slide into a shim extended position wherein the shim engages the slot in the jamb of the rollup door.

17. The method of claim 16 wherein the step of providing a shim includes providing a shim having a shim tab at a shim proximal end and a shim tang at shim distal end and wherein the shim tab includes a hole sized to accommodate the shank of a second lock.

18. The method for securing a rollup door of claim 16 wherein the step of providing a shim includes providing a shim having a length so that when the shim is positioned in the shim extended position, the shim proximal end is positioned proximally of a proximal end of the latch slide.

19. The method for securing a rollup door of claim 16 wherein the step of providing a shim includes providing a shim having a length so that when the shim is positioned in the shim extended position, the shim proximal end is positioned distally of a proximal end of the latch slide.

20. The method for securing a rollup door of claim 17 wherein, when the shim is in the shim extended position, the shim tab hole aligns with a slot in a latch cover of the door latch assembly.
